(19) United States
(12) Patent Application Publication
(10) Pub. No.: US 2011/0154369 A1
(43) Pub. Date: Jun. 23, 2011

(54) SYSTEM AND METHOD FOR THE GENERIC INTEGRATION OF A USER INTERFACE IMPLEMENTATION FRAMEWORK AND A PERSISTENCY IMPLEMENTATION FRAMEWORK

(75) Inventors: Frederik Thormaehlen, Mannheim (DE); Karthikeyan Loganathan, Bangalore (IN)

(73) Assignee: SAP AG, Walldorf (DE)

(21) Appl. No.: 12/640,523

(22) Filed: Dec. 17, 2009

(51) Int. Cl. G06F 9/54

(52) U.S. Cl. 719/318

(57) ABSTRACT

A method and system for providing an integration framework to integrate a user interface framework with a persistency framework. The integration framework provides components to integrate user interface components with business objects by configuration of generic integration components instead of programming specialized integration components

### FIELD OF THE INVENTION

The embodiments of the invention relate to an integration framework for providing configurable components that link a user interface framework with a persistency framework. More specifically, the embodiments of the invention provide configurable components to link user interface components and persistent business objects.

### BACKGROUND

In many enterprise systems, the user interface functionality is separated and distinct from the business logic. The user interface functionality may be structured, architecturally, as a user interface framework. In the user interface framework, the components of the user interface, such as forms, menus, reports and windows can be defined as discrete using interface building blocks or user interface components. These user interface components are the front end of the enterprise system that enables the user to interact with the functionality of the enterprise system that is provided by the business logic. The user interface components present data received from these business objects and pass data to the business logic that is received from the user interaction with the user interface.

The business logic is provided through a set of business objects. These business objects are code that implements the business logic. The business objects are stored and maintained by a persistency framework. The interaction between the user interface building blocks and business objects is enabled by a specialized coding that ties the user interface components to the business objects. The coding that integrates the user interface components with the business objects is specialized and manually coded specifically for each relationship between a user interface component and a business object. This is a time and resource intensive process that requires the skills of a programmer.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1 is a diagram of one embodiment of a system implementing the integration framework.

FIG. 2 is a flowchart of one embodiment of the design time functioning of the integration framework.

FIG. 3 is a flowchart of one embodiment of the run time functioning of the integration framework.

### DETAILED DESCRIPTION

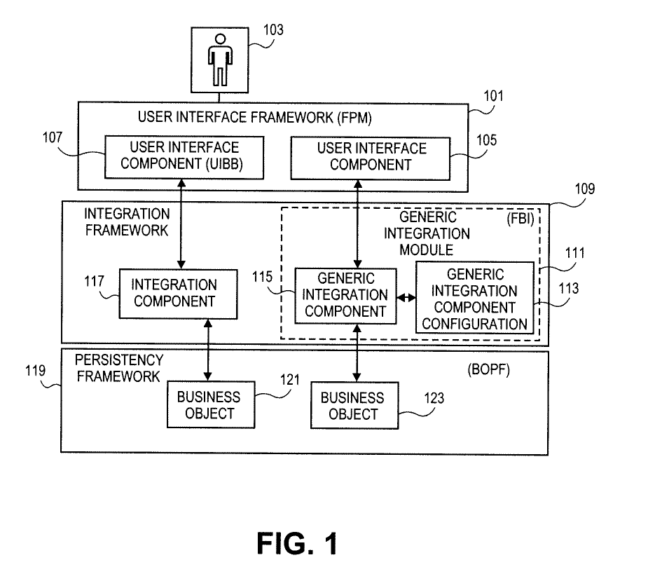

FIG. 1 is a diagram of one embodiment of a system implementing the integration framework. In one embodiment, the system includes a user interface framework 101, integration framework 109 and a persistency framework 119. Each of the frameworks can be implemented on a single computer system or can be distributed across multiple computer systems. Computer systems can be desktop computers, workstations, servers or similar computing devices. These computing devices can be networked together using a local area network (LAN), a wide area network (WAN), such as the Internet, or similar communication system. This networked grouping of computer systems can be utilized to implement a distributed environment where different aspects of the frameworks are implement by different computer systems in the networked grouping.

In one embodiment, the user interface framework 101 can be implemented as a set of user interface level programs that support the execution of user interface components 105, 107. These user interface components 105, 107 can be implemented as freestyle user interface building blocks (UIBB) or generic user interface building blocks (GUIBB). As used herein, ‘freestyle’ means coded by each and every developer individually. As used herein, ‘generic’ means implemented by one developer and reused by all developers or a group of developers. A ‘set,’ as used herein, refers to any positive whole number of items including one item. The user interface components can represent or define forms, records, tables, menus, windows and similar text-based or graphical user interfaces for viewing and inputting data. In one example embodiment, the user interface framework is a floorplan manager (FPM) application by SAP AG of Walldorf, Germany.

Each user interface component 105, 107 is tied to a business object 121, 123 in the persistency framework 119. A business object 121, 123 is a data structure and set of code that defines or supports business logic to perform a specific task, perform a function or manage a data set. The persistency framework 119 manages the storage, interfacing and execution of these business objects 121, 123. Any number of business objects 121, 123 can be defined and maintained by the persistency framework 119. In one example embodiment, the persistency framework is a Business Object Persistency Framework (BOPF) by SAP AG of Walldorf, Germany.

The relationships between the user interface components 105, 107 and the business objects 121, 123 are defined by the integration components 115, 117. A standard integration component 117 provides a dedicated and specific coding of the interrelationship between the user interface component 107 and the business object 121. The standard integration component 117 defines the relationship between all the fields and user interface mechanisms of the user interface component 107 and each of the fields, functions and methods of a business object 121. This enables the user 103 to interact with the user interface component 107 to retrieve data from the business object 121, store data in the business object 121 or make use of the functionality of the business object 121. A separate integration component 117 is defined for each business object 121 and user interface component 107 pairing.

In another embodiment, the user interface component 105 can be linked with a business object 123 through a generic integration component 115. A generic integration component 115 can be utilized to tie any user interface component 105 to any business object 123. This is a component that can be replicated or instanced such that any number of user interface components 105 and business objects 123 can be linked together in a one-to-one relationship using an instance or copy of the generic integration component 115. The generic integration component 115 does not have to be specially coded or otherwise require any programming on the part of the user. Instead, the user can define a generic integration component configuration 113 that maps each of the aspects or elements of the user interface component 105 to the desired components of the business object 123.

This functionality is provided by the generic integration module 111 and thereby enables the development of new user interfaces or business objects and the tying of these new user interface components and business objects together without the need for specialized integration components to be programmed. The configuration of the generic integration module 111 can be done through any type of interface including a graphical user interface, command line interface or similar user interface provided by the generic integration module 111 individually or in combination with the user interface framework 101. Avoiding the need for a programmer reduces costs and improves the accessibility and utility of the system in terms of being able to quickly deploy new user interface component and business object related functionality. In one example embodiment, the generic integration module 111 is a FPM-BOPF Integration (FBI) module, by SAP AG of Walldorf, Germany.

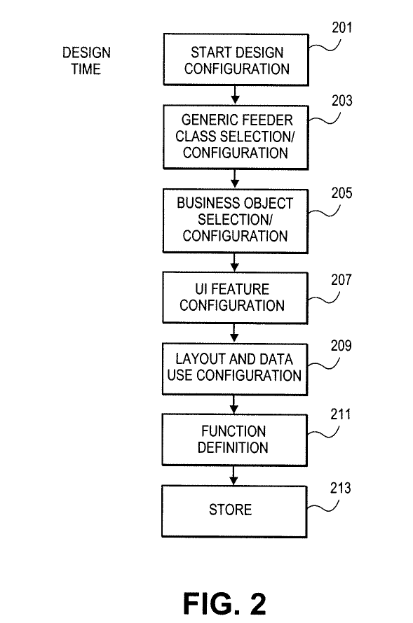

FIG. 2 is a flowchart of one embodiment of the design time functioning of the integration framework. In one embodiment, this process is begun by the user selecting to configure a generic integration component for a specific business object and user interface component pair (Block 201). The design configuration interface can be any type or combination of graphical, text-based or similar user interface. The design interface can provide the user with a set of generic feeder class options and a set of menus for configuring these generic feeder classes.

The user then selects from this set of generic feeder classes (Block 203). These feeder classes represent different types of interrelationships between user interface objects and business objects. For example, some feeder classes may be appropriate for use between user interface components that represent forms and business objects that store or process the data from these forms. The user can configure some aspects of the generic feeder class that are not specific to its relationship with the user interface component or business object.

The user then selects a business object to be linked to the selected feeder class (Block 205). The user configures the generic feeder to work with the selected business object. This configuration can include identifying fields, functions or methods of the business object to access or interface. Similarly, the user then selects the user interface component or building block to be linked to the selected feeder class (Block 207). The user then configures the generic feeder class to interface with the user interface component by selecting the fields and interaction mechanisms to be serviced by the generic feeder class. The configuration of the interface between the generic feeder class and associated business object and user interface component do not require any programming skills of the user. The configuration process can be guided or non-guided. A guided process can prompt a user to define relationships specific to the selected user interface components and business objects.

In one embodiment, layout and data use are then configured (Block 209). The layout of the user interface and the use of the data input into the user interface component can be configured. Function definitions are then entered (Block 211). The functions to be performed on the data from the user interface component and the functions to be executed in response to user interface component input as well as business object responses are configured. The configuration of these aspects of the generic feeder class can also be accomplished through graphical, text-based or similar user interface features. The user may be allowed to select each of the configuration options from menus or similar user interface mechanisms. The options may be constrained to a set of pre-defined options or options specific to the generic feeder class, user interface component or business object. In some embodiments, configuration of functions can encompass the use of Boolean logic or similar representation of logic or operations using similar representations that are commonly understood and utilized by non-programmers. The resulting configuration is stored (Block 213). The configuration is stored as a generic integration component configuration and is accessed or utilized to instantiate an instance of the generic feeder class according to the configuration of the user at run-time.

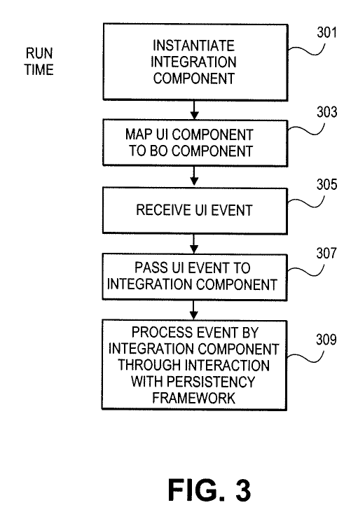

FIG. 3 is a flowchart of one embodiment of the run time functioning of the integration framework. This process may be initiated by instantiation of an integration component such as a generic integration component (Block 301). The process is executed by the generic integration module. The process may be initiated in response to a user action that opens a corresponding user interface component or similar interaction with the enterprise system. During the instantiation of the generic integration component the corresponding user interface component is mapped to the corresponding business object component (Block 303). The mapping is generated based on the configuration data retrieved from the generic integration component configuration.

When a user interface event is detected in response to a user interaction with the user interface component or building block (Block 305), the user interface event is passed to the generic integration component (Block 307). The integration component processes the event through interaction with the persistency framework and the corresponding business object component (Block 309). In one embodiment, the processing by the business object can result in a reply or return value that is passed from the business object or persistency framework back to the integration component, which in turn passes the data to the user interface component or updates the user interface component.

In one embodiment, the user interface framework, persistency framework and integration framework can be implemented as a set of individual or combined hardware devices. In another embodiment, the system components are implemented in software (for example microcode, assembly language or higher level languages). These software implementations can be stored on a computer-readable medium. A “computer-readable” medium can include any medium that can store information. Examples of the computer-readable medium include a read only memory (ROM), a floppy diskette, a CD Rom, a DVD, a flash memory, a hard drive, an optical disc or similar medium.

In the foregoing specification, the invention has been described with references to specific embodiments. It will, however, be evident that various modifications and changes can be made thereto without departing from the broader spirit and scope that is set forth in the appended claims. The specification and drawings are accordingly to be regarded in illustrative rather than a restrictive sense.

What is claimed is:

1. A method comprising:
receiving an event from a user interface component in a user interface framework; and
processing the event by a generic integration component through interaction with a persistency framework.

2. The method of claim 1, further comprising:
mapping the user interface component to a business objecting of the persistency framework.

3. The method of claim 2, wherein the integration component comprises:
a generic feeder class configured to integrate the user interface component of the user interface framework with a business object of the persistency framework.

4. A method comprising:
receiving a selection of an integration component;
receiving a selection of a business object;
receiving a selection of a user interface component; and
storing an integration component configuration defining a relationship between the business object and the user interface component to be serviced by the integration component.

5. The method of claim 4, further comprising:
receiving user interface component configuration data; and
storing the user interface component configuration data in the integration component configuration.

6. The method of claim 4, further comprising:
receiving business object configuration data; and
storing the business object configuration data in the integration component configuration.

7. The method of claim 4, further comprising:
receiving user interface component and business object mapping data; and
storing the mapping data in the interface component configuration data.

8. The method of claim 4, further comprising:
receiving a function definition to define a process to apply to data passed between the user interface component and the business object; and
storing the function definition in the integration component configuration.

9. A system comprising:
a user interface framework to provide a user interface component for an application;
a persistency framework to provide business object including business logic and data for the application; and
an integration framework to integrate the user interface component with the business object through a configured generic interface component.

10. The system of claim 9, wherein the generic interface component is a generic feeder class.

11. The system of claim 9, wherein the generic interface component processes events received from the user interface framework by interaction with the persistency framework.

12. A computer-readable medium having stored therein a set of instructions, which when executed, cause a computer to perform a set of operations comprising:
receiving an event from a user interface component in a user interface framework; and
processing the event by a generic integration component through interaction with a persistency framework.

13. The computer-readable medium of claim 12, having further instructions stored therein, which when executed, cause the computer to perform a further set of operations comprising:
mapping the user interface component to a business objecting of the persistency framework.

14. The computer-readable medium of claim 13, wherein the integration component comprises:
a generic feeder class configured to integrate the user interface component of the user interface framework with a business object of the persistency framework.

15. A computer-readable medium having stored therein a set of instructions, which when executed, cause a computer to perform a set of operations comprising:
receiving a selection of an integration component;
receiving a selection of a business object;
receiving a selection of a user interface component; and
storing an integration component configuration defining a relationship between the business object and the user interface component to be serviced by the integration component.

16. The computer-readable medium of claim 15, having further instructions stored therein, which when executed, cause the computer to perform a further set of operations comprising:
receiving user interface component configuration data; and
storing the user interface component configuration data in the integration component configuration.

17. The computer-readable medium of claim 15, having further instructions stored therein, which when executed, cause the computer to perform a further set of operations comprising:
receiving business object configuration data; and
storing the business object configuration data in the integration component configuration.

18. The computer-readable medium of claim 15, having further instructions stored therein, which when executed, cause the computer to perform a further set of operations comprising:
receiving user interface component and business object mapping data; and
storing the mapping data in the interface component configuration data.

19. The computer-readable medium of claim 15, having further instructions stored therein, which when executed, cause the computer to perform a further set of operations comprising:
receiving a function definition to define a process to apply to data passed between the user interface component and the business object; and
storing the function definition in the integration component configuration.
